(19) United States
(12) Patent Application Publication
(10) Pub. No.: US 2016/0210822 A1
(43) Pub. Date: Jul. 21, 2016

(54) RACING LOTTERY GAME

(71) Applicant: Intralot S.A. Integrated Lottery Systems and Services, Athens (GR)

(72) Inventors: Evangelos Kalloudis, Athens (GR); Panagiotis Koustenis, Athens (GR)

(73) Assignee: Intralot S.A. Integrated Lottery Systems and Services, Athens (GR)

(21) Appl. No.: 14/995,298

(22) Filed: Jan. 14, 2016

Related U.S. Application Data
(60) Provisional application No. 62/103,632, filed on Jan. 15, 2015.

(51) Int. Cl. G07F 17/32; A63F 13/57

(52) U.S. Cl. CPC G07F 17/3276; G07F 17/329; A63F 13/57

(57) ABSTRACT

A game combines the features of a lottery game and a race game. The actual race itself is conducted with each race participant being assigned specific numbers. Specific finishers of the race are determined (i.e., first through third place finishers) and the numbers associated with those finishers form a pool from which random numbers are drawn to determine a winner. Thus, the game combines the element of chance with the excitement of a race and permits the participants to exercise discretion in influencing the odds for ultimately winning the game. This combination of elements is such that the interest of the participants is maintained throughout the game from initial selection of the participants to the eventual running of the race and drawings of the winners.

This claims the benefit of U.S. Provisional Patent Application Ser. No. 62/103,632, filed Jan. 15, 2015 and hereby incorporated by reference in its entirety.

### BACKGROUND OF THE INVENTION

This invention relates to a race game, and in particular to a combined race and lottery game which can be played by a variety of people, some of which may wish to enrich their experience with skill in addition to luck.

There are a number of prior art race games wherein miniature representations of racers are incrementally moved around a miniature track based on the throw of dice, actuation of a spinner, the drawing of cards having numbers thereon, and the like. In such games, however, the outcome of the event is based solely on chance and the outcome of the various rolls, spins, draws or the like.

Another group of prior art games includes games of chance wherein one or several players are selected from a larger group of players participating in the game. An example of this type of game includes standard lotteries wherein a large number of people purchase lottery tickets, but only a small number of tickets are selected and the participants are rewarded based on the tickets selected. Generally, the tickets are placed in a common container and drawn at random, so the participants are not capable of influencing the odds that their tickets will be drawn.

A drawback to the prior art race games is that there is little in the way of generating interest aside from the mechanics of rolling dice or spinning a spinner to move the participants around the track. In the case of a lottery, because the draw is completely random, the only means for increasing the odds of winning is to purchase a larger number of tickets. Once the ticket or tickets have been purchased, however, the participants have nothing to do except await the outcome of the draw.

### SUMMARY OF THE INVENTION

A game according to various embodiments of this invention overcomes the disadvantages of the above-discussed prior art games and others by combining the features of a lottery game and a race game. Specifically, in one embodiment the actual race itself is conducted with each game participant being assigned specific numbers. Specific finishers of the race are determined (i.e., the top five finishers) and the numbers associated with those finishers form the pool from which random numbers are drawn to determine a game winner. The game can be organized such that the players will know in advance the race participants, which may indicate the odds of any given racer finishing ahead of the remaining racers. With this knowledge, the players can select or purchase tickets which will increase their odds of being represented in the pool. Thus, the game combines the element of chance with the excitement of a race and permits the participants to exercise discretion in influencing the odds for ultimately winning the game. This combination of elements is such that the interest of the participants is maintained throughout the game from initial selection of the race participants to the eventual running of the race and drawings of the game winners.

This invention also relates to a method and a system for playing a combined race and lottery game. Each player selects one or more racers of his choice and hereby is assigned selected numbers associated with each racer. The race is conducted and the finishing place is determined for each racer based on the outcome of the race. The numbers associated with the racers of the selected finishers form the pool from which the winning lottery numbers are drawn.

In one form of the invention, the odds of a racer winning the race will increase the likelihood those assigned numbers will appear in the pool for the lottery draw. The players desiring to increase their odds of winning will select the most favorable racers.

The various strategies and skill involved in the selection of racers pertaining to a particular race maintains the interest of the participants, as opposed to the above-discussed prior art games and others which are much simpler and do not permit any discretionary judgment on the part of the participants. Moreover, the game according to the invention is quite versatile in that it can be played by groups of varying sizes, such as at private parties or banquets, entire companies, and can even be played on a state or national level coinciding, if desired, to races in which there is national interest, such as the Kentucky Derby®.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a chart showing one exemplary embodiment of a game matrix according this invention including a joker aspect;

FIG. 2 is a chart showing one exemplary embodiment of a game matrix according this invention without a joker aspect;

FIG. 3 is a flow chart of one embodiment of a method of conducting a game according to this invention; and

FIG. 4 is an exemplary display of various components of one system which could be used to implement this invention.

### DETAILED DESCRIPTION OF THE INVENTION

In various embodiments, this invention is directed to a family of unique and new lottery products based on a racing theme or format with flexible betting frequency targeting players from both the lottery and racing markets.

In various embodiments, this racing lottery family of games is a combination of lottery and racing game play:
(I) Lottery Game play: Players are asked to predict X out Y numbers;
(II) Racing Game play: Players are asked to predict the first X racers of a race.

The racing lottery games are based on dynamic matrices and number allocation techniques, replicating the most popular lottery games, together with the result of a race, enriching the lottery games with skill and not only luck.

The games can be offered on any type of racing event with a consecutive finishing order such as horse racing, greyhound racing, motor racing (Formula 1, NASCAR, Superbikes, Cycling etc.) whether live or virtual (3D animated) or pre-recorded, in any draw frequency either hourly, daily or weekly, depending on a market's needs.

Players are asked to predict X numbers out of Y, and a “Joker” number in some variations. A unique set of numbers corresponds to each discrete racer, all sets are of equivalent size. For example, a set may be five numbers per racer, meaning that numbers in the set 1-5 correspond to racer no. 1, numbers in another set 6-10 correspond to racer no. 2 and so on (Y numbers in total). After the end of the race, the first racers' set of numbers enters a lottery draw from which the X winning number series is drawn. For example, the first five racers generate a pool of twenty-five numbers, 25=5×5, from which the five winning lottery numbers may be drawn.

As in most live racing events, each racer has its own probability of winning; therefore, players have the ability to study the race participants and select their corresponding numbers to increase their probabilities of winning. For the virtual and pre-recorded races, all racers and their associated set of numbers may have the same probability. Virtual and pre-recorded races can be used for the high frequency game versions.

The prize structure may be flexible, depending on market needs, either as a large jackpot generating game or with smaller prizes with more frequent draws. A TV show may accompany the lottery draw.

The above described aspects can replicate many famous lottery games such as Greece's Joker and Lotto, Italy's SuperEnaLotto and many more in order to meet a variety of regulatory frameworks.

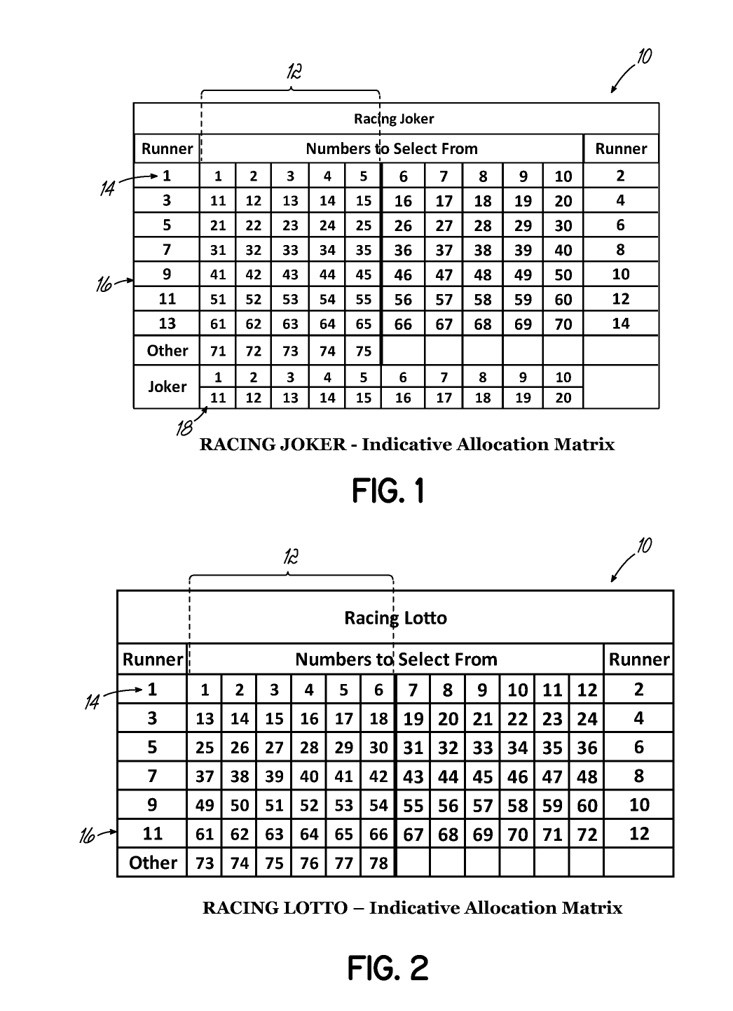

According to selected embodiments, this invention may encompass a racing lottery game with indicative variations including a racing joker embodiment as now will be described with reference to FIG. 1.

In one embodiment of a game 10 according to this invention as shown in FIG. 1, a set 12 of five numbers are allocated to each racer 14 of an upcoming fifteen participant race 16. In FIG. 1, the fifteen racers 16 are designated 1-14 and “Other”. A limit may be placed on the number of racers in each race (i.e., no more than eighteen racers 14 in a given race 16 are allowed). The row “Other” field in FIG. 1 may be for all racers 14 above fourteen.

Players predict or quick pick five racers' and their associated set of five numbers 12 and the joker number 18 from 1-75 and 1-20, respectively. The set 12 of numbers allocated to the first five winning racers 14 enter a lottery draw (i.e. the first five racers may be racers identified as Runners 1-3-6-7-10 as shown in FIG. 1). Those top five racers 14 have allocated sets 12 of numbers “1, 2, 3, 4, 5, 11, 12, 13, 14, 15, 26, 27, 28, 29, 30, 31, 32, 33, 34, 35, 46, 47, 48, 49, 50” as seen in FIG. 1 and those numbers form a pool 19 for a lottery draw, from which the winning numbers (i.e., five winning numbers) may be randomly drawn (i.e., winning numbers 3-11-27-30-46 may be drawn). The winning joker number 18 may be drawn in a second independent draw (i.e., 17 may be the drawn winning joker number).

The prize structure may be flexible and prizes may be distributed to the below indicative categories, but not limited to, either as fixed amounts and/or as pool amounts. Indicative Prize Categories (from the racer's numbers 1-75 and the Joker number) are as follows:

1^{st} Prize Category: all 5 racer's numbers and the joker number are drawn;
2^{nd} Prize Category: all 5 racer's numbers, but not the joker number are drawn;
3^{rd} Prize Category: only 4 racer's numbers and the joker number are drawn;
4^{th} Prize Category: only 4 racer's numbers, but not the joker number are drawn;
5^{th} Prize Category: only 3 racer's numbers and the joker number are drawn;
6^{th} Prize Category: only 3 racer's numbers, but not the joker number are drawn;
7^{th} Prize Category: only 2 racer's numbers and the joker number are drawn; and
8^{th} Prize Category: only 2 racer's numbers, but not the joker number are drawn.

Indicative Assumptions:
$0.50 price/column
Approx. 50% payout

| | Theoretical Prize |
|---|---|
| 1st Prize Category | $34,354,294 |
| 2nd Prize Category | $804,114 |
| 3rd Prize Category | $20,181 |
| 4th Prize Category | $404 |
| 5th Prize Category | $228 |
| 6th Prize Category | $9 |
| 7th Prize Category | $5 |
| 8th Prize Category | $2 |

According to selected alternative embodiments, this invention may encompass a racing lottery game with indicative game variations without a joker as now will be described with reference to FIG. 2.

In one embodiment of the game 10 according to this invention as shown in FIG. 2, the set 12 of six racer's numbers may include six numbers allocated to each racer 14 for a thirteen-racer race 16. No more than eighteen racers are allowed. The row “Other” is for all racers 14 above twelve.

Each player may predict or quick pick six racers' and their associated set of six numbers out of 78 available. The numbers allocated to the first six winning racers form the pool 12 to enter a lottery draw (i.e. the first six racers are: 1-3-6-7-10-13). Their allocated numbers may be “1, 2, 3, 4, 5, 6, 13, 14, 15, 16, 17, 18, 31, 32, 33, 34, 35, 36, 37, 38, 39, 40, 41, 42, 55, 56, 57, 58, 59, 60, 73, 74, 75, 76, 77, 78” from the pool 19 and one entered into the lottery draw, from which the six winning numbers are randomly drawn (i.e., “3-15-32-36-42-56” are drawn from the pool as winning numbers). In this embodiment, a joker number is not drawn.

The prize structure may be flexible and prizes may be distributed to the below indicative categories, but not limited to, either as fixed amounts and/or as pool amounts. Prize Categories (from 1-78):

1^{st} Prize Category: all six racers' numbers are drawn;

2^{nd} Prize Category: only five of the six racer's numbers are drawn;

3^{rd} Prize Category: only four of the six racer's numbers are drawn;

4^{th} Prize Category: only three of the six racer's numbers are drawn;

Assumptions:
$0.50 price/column
Approx. 50% payout

| | Theoretical Prize |
|---|---|
| 1st Prize Category | $26,595,069 |
| 2nd Prize Category | $22,030 |
| 3rd Prize Category | $259 |
| 4th Prize Category | $6 |

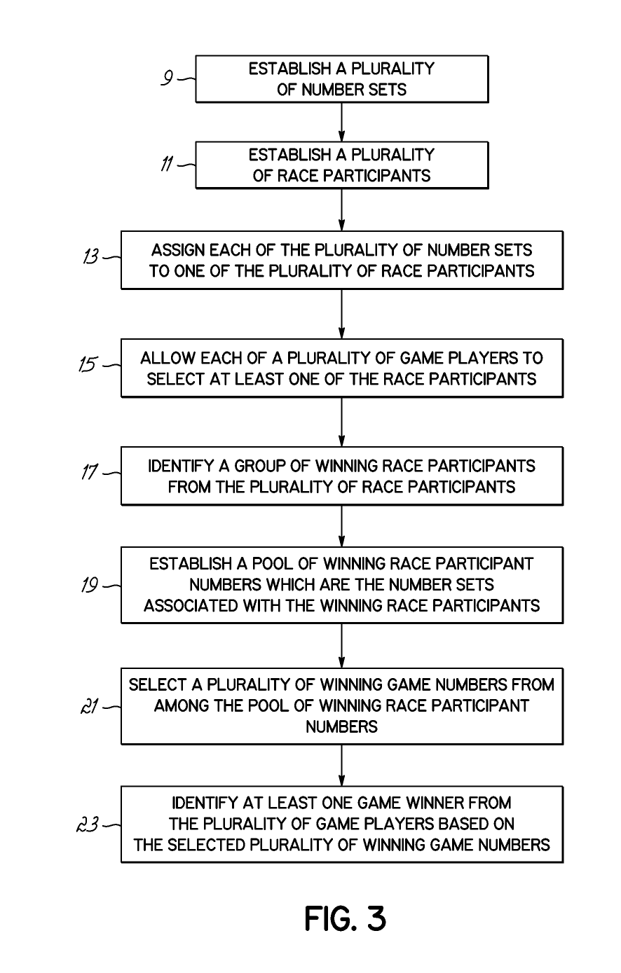

Referring to FIG. 3, one embodiment of a method for conducting a game according to this invention is shown. Initially, a pluralit of number sets is established 9 and then a plurality of race participants is established 11. Each of the plurality of number sets is assigned to one of the plurality of the race participants 13. Then, each of the game players is allowed to select at least one of the race participants 15.

A group of winning race participants from the plurality of race participants is then identified 17 via a live race, a previously held race or the like. A pool of race participant numbers is established 19 which are the number sets associated with the winning race participants.

Next, a plurality of winning game numbers may be drawn from among the pool of winning race participant numbers 21 and a least one game winner is then identified based on the selected winning game numbers 23. The method displayed in FIG. 3 does not include the racing joker embodiment and, therefore, corresponds more closely to the embodiment of this invention shown in FIG. 2. However, one of ordinary skill in the art will appreciate that a similar method may be utilized within the scope of this invention which includes the joker aspect.

It will be appreciated that the embodiments described and shown herein utilize numbers, but the invention may be employed utilizing characters other than or in addition to numbers. As such, the terms “character”, “characters” and the like are utilized herein and in the claims as collective terms encompassing the use of numbers, letters, and any other symbol for carrying out this invention.

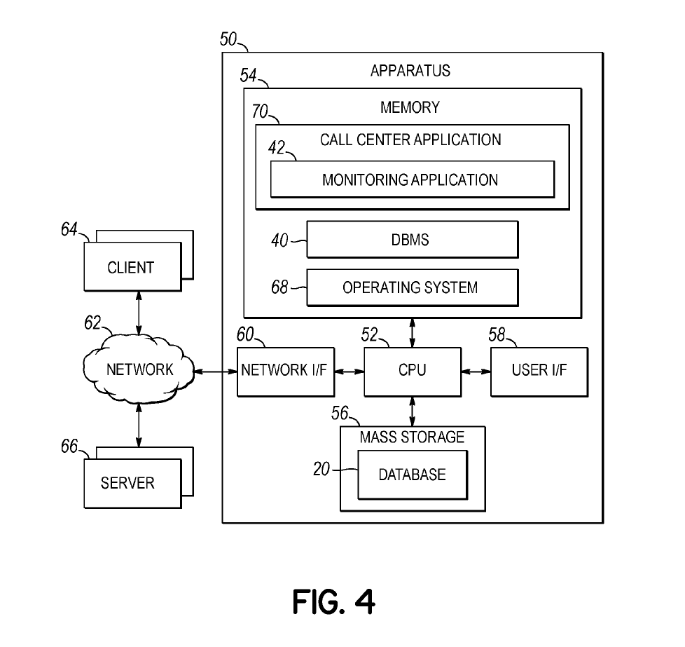

The game 10 may be conducted on a system including various computer elements. For example, turning to FIG. 4, an exemplary hardware and software implementation of the game, within an apparatus 50, is illustrated. For the purposes of the invention, apparatus 50 may represent practically any type of computer, computer system or other programmable electronic device, and will be referred to hereinafter as a computer for simplicity. It will be appreciated, however, that apparatus 50 may be implemented using one or more networked computers, e.g., in a cluster or other distributed computing system, or may be implemented within a single computer or other programmable electronic device, e.g., a desktop computer, laptop computer, handheld computer, cell phone, set top box, etc.

Computer 50 typically includes a central processing unit 52 including at least one microprocessor coupled to a memory 54, which may represent the random access memory (RAM) devices comprising the main storage of computer 50, as well as any supplemental levels of memory, e.g., cache memories, non-volatile or backup memories (e.g., programmable or flash memories), read-only memories, etc. In addition, memory 54 may be considered to include memory storage physically located elsewhere in computer 50, e.g., any cache memory in a processor in CPU 52, as well as any storage capacity used as a virtual memory, e.g., as stored on a mass storage device 56 or on another computer coupled to computer 50. Computer 50 also typically receives a number of inputs and outputs for communicating information externally. For interface with a user or operator, computer 50 typically includes a user interface 58 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 50 may also include one or more mass storage devices 56, e.g., a floppy or other removable disk drive, a hard disk drive, a direct access storage device (DASD), an optical drive (e.g., a CD drive, a DVD drive, etc.), and/or a tape drive, among others. Furthermore, computer 50 may include an interface 60 with one or more networks 62 (e.g., a LAN, a WAN, a wireless network, and/or the Internet, among others) to permit the communication of information with other computers and electronic devices, e.g., one or more client computers 64 (e.g., for interfacing with agents) and one or more servers 66 (e.g., implementing other aspects of service). It should be appreciated that computer 50 typically includes suitable analog and/or digital interfaces between CPU 52 and each of components 54, 56, 58 and 60 as is well known in the art. Other hardware environments are contemplated within the context of the invention.

Computer 50 operates under the control of an operating system 68 and executes or otherwise relies upon various computer software applications, components, programs, objects, modules, data structures, etc., e.g., a call center application 70 (within which, for example, monitoring application 42 may be implemented). Moreover, various applications, components, programs, objects, modules, etc. may also execute on one or more processors in another computer coupled to computer 50 via network 62, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by computer 50. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method of conducting a combined lottery and racing game for a plurality of game players, the method comprising the steps of:
establishing a plurality of character sets;
establishing a plurality of race participants;
assigning each of the plurality of character sets to one of the plurality of race participants;
each of the plurality of game players selecting at least one of the race participants;
identifying a group of winning race participants from the plurality of race participants;
establishing a pool of winning race participant characters which are the character sets associated with the winning race participants;
selecting a plurality of winning game characters from among the pool of winning race participant numbers; and
identifying at least one game winner from the plurality of game players based on the selected plurality of winning game characters.

2. The method of claim 1 wherein each of the character sets includes one of five characters and six characters.

3. The method of claim 1 wherein the identifying the group of winning race participants further comprises monitoring a live race event.

4. The method of claim 1 wherein the selecting each of the race participants step further comprises assigning the race participants randomly.

5. The method of claim 1 wherein the selecting the plurality of winning game characters step further comprises selecting the plurality of winning game characters randomly.

6. The method of claim 1 further comprising:
awarding a prize to the at least one game winner.

7. The method of claim 1 further comprising:
establishing a pool of characters distinct from the plurality of character sets;
allowing each of the plurality of game players to select at least one of the characters from the pool of characters;
selecting a winning character from the pool of winning characters; and
determining if any of the plurality of game players selected the winning character.

8. The method of claim 7 further comprising:
awarding a prize to the at least one game winner dependent upon the winning character and the selected plurality of winning game characters.

9. The method of claim 1 wherein the characters are each numbers.

10. A method of conducting a combined lottery and racing game for a plurality of game players, the method comprising the steps of:
establishing a plurality of number sets wherein each of the number sets includes one of five numbers and six numbers;
establishing a plurality of race participants;
assigning each of the plurality of number sets to one of the plurality of race participants;
each of the plurality of game players selecting at least one of the race participants;
identifying a group of winning race participants from the plurality of race participants;
establishing a pool of winning race participant numbers which are the number sets associated with the winning race participants;
randomly selecting a plurality of winning game numbers from among the pool of winning race participant numbers;
identifying at least one game winner from the plurality of game players based on the selected plurality of winning game numbers; and
awarding a prize to the at least one game winner.

11. The method of claim 10 wherein the identifying the group of winning race participants further comprises monitoring a live race event.

12. The method of claim 10 wherein the selecting each of the race participants step further comprises assigning the race participants randomly.

13. The method of claim 10 further comprising:
establishing a pool of numbers distinct from the plurality of number sets;
allowing each of the plurality of game players to select at least one of the numbers from the pool of numbers;
selecting a winning number from the pool of winning numbers; and
determining if any of the plurality of game players selected the winning number.

14. The method of claim 13 further comprising:
awarding a prize to the at least one game winner dependent upon the winning number and the selected plurality of winning game numbers.
